(19) United States
(12) Patent Application Publication
(10) Pub. No.: US 2025/0078031 A1
(43) Pub. Date: Mar. 6, 2025

(54) AUTOMATICALLY TRIGGER WORKORDERS ON A SITE IN A WIRELESS NETWORK

(71) Applicant: Rakuten Symphony, Inc., Tokyo (JP)

(72) Inventors: Akash VERMA, Indore (IN); Yogesh PATIL, Indore (IN)

(73) Assignee: Rakuten Symphony, Inc., Tokyo (JP)

(21) Appl. No.: 18/041,459

(22) PCT Filed: Dec. 27, 2022
(86) PCT No.: PCT/US2022/054053

§ 371 Date: Feb. 13, 2023

(30) Foreign Application Priority Data
Nov. 14, 2022 (IN) 202221065064

(51) Int. Cl. G06Q 10/10; G06Q 10/0631

(52) U.S. Cl. CPC G06Q 10/103; G06Q 10/06311

(57) ABSTRACT

Embodiments herein disclose a method and system (100) for automatically triggering workorder in a wireless network, wherein the system (100) includes: a site management server (104) includes information of a plurality of sites; a workorder management server (101) includes a plurality of workorders and a plurality of workorder templates, and a workflow management server (106), communicatively coupled to the workorder management server (101) and the site management server (104). The workflow management server (106) is configured to create a project connector configuration based on the information of a site of the plurality of sites and workorder template of the plurality of workorder templates and automatically trigger a workorder of the plurality of workorders to the site management server (104) based on the project connector configuration.

### FIELD OF INVENTION

The embodiments herein relate to a workflow management server, and more particularly relates to a method and the workflow management server for automatically triggering workorders in a wireless network.

### BACKGROUND OF THE INVENTION

Generally, workorders help organizations manage maintenance work. The workorders describe tasks or jobs that are triggered to technicians for completing the maintenance work on a site. The workorders are an engine for the maintenance work and it needs to be triggered at a correct time, to a correct person and at a correct location.

Hence there is a high demand for triggering the workorders to the technicians in order to manage the maintenance work.

The conventional method for triggering the workorders is suitable for a small or single site in a single location. However the conventional method cannot be used for multi-site portfolio managers, and it cannot be used when the site is located in multiple locations.

In some other conventional methods, a user needs to create a template and then by using the template to trigger the workorders manually on the site however this results in unnecessary delays in processing and in the maintenance work.

Thus, it is desired to address the above mentioned disadvantages or other shortcomings or at least provide a useful alternative.

### OBJECT OF INVENTION

The principal object of the embodiments herein is to provide a method and a workflow management server for automatically triggering workorder on a site or on a new site in a wireless network to increase speed in taking corrective action.

Another object of the embodiments herein is to create a project connector configuration based on information of the site of a plurality of sites and workorder template of a plurality of workorder templates, wherein the project connector configuration triggers a workorder automatically on the site or on a different based on the configuration done in the project connector.

Another object of the embodiments herein is to automatically trigger workorder of the plurality of workorders to a site management server which automates the process of triggering workorder on the site or a facility or a location via a workflow.

### SUMMARY

Accordingly, the embodiments herein disclose a system for automatically triggering workorders in a wireless network, wherein the system includes a site management server includes information of a plurality of sites; a workorder management server includes a plurality of workorders, and a plurality of workorder templates, wherein each workorder of the plurality of workorders is created based on workorder template of the plurality of workorder templates, and wherein each workorder template of the plurality of workorder templates includes a plurality of workflows to be performed on a site of the plurality of sites; and a workflow management server, communicatively coupled to the workorder management server and the site management server. The workflow management server is configured to create a project connector configuration based on the information of a site of the plurality of sites and workorder template of the plurality of workorder templates and automatically triggers a workorder of the plurality of workorders to the site management server based on the project connector configuration.

In an embodiment, the workflow management server is configured to determine a new site based on the project connector configuration by mapping a site identifier indicated in the project connector configuration and a site identifier included in the workorder template based on which the workorder is created to be triggered.

Accordingly, the embodiments herein disclose a method for automatically triggering workorders in a wireless network, wherein the method includes: creating and storing a plurality of workorder templates includes a plurality of site parameters of a site from a plurality of sites, information of the site related to a project connector configuration and a site identifier: creating and storing at least one workorder that needs to be triggered based on a workorder template from the plurality of workorder templates: creating a project connector configuration based on the information of the site of the plurality of sites and workorder template of the plurality of workorder templates; and automatically trigger the workorder of the plurality of workorders based on the project connector configuration.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 is a block diagram illustrating a system includes a site management server, a workorder management server, and a workflow management server in a wireless network, according to the embodiments as disclosed herein;

FIG. 2 is a flow diagram illustrating a method for automatically triggering workorder in the wireless network, according to the embodiments as disclosed herein;

FIG. 3 is a sequential diagram illustrating triggering of workorder on a site or a new site identifier in the wireless network, according to the embodiments as disclosed herein;

FIG. 4A is a schematic diagram illustrating a mapping of a site identifier included in a workorder template of the project connector configuration, according to the embodiments as disclosed herein;

FIG. 4B is a schematic diagram illustrating the mapping of the new site identifier indicated in a project connector configuration, according to the embodiments as disclosed herein;

FIG. 5 is a schematic diagram illustrating a workorder template creation window, according to the embodiments as disclosed herein; and

FIG. 6 is a schematic diagram illustrating a workorder creation template, according to the embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be constructed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments herein disclose a system for automatically triggering workorder in a wireless network, wherein the system includes a site management server includes information of a plurality of sites; a workorder management server includes a plurality of workorders and a plurality of workorder templates, wherein each workorder of the plurality of workorders is created based on workorder template of the plurality of workorder templates, and wherein each workorder template of the plurality of workorder templates includes a plurality of workflows to be performed on a site of the plurality of sites; and a workflow management server, communicatively coupled to the workorder management server and the site management server. The workflow management server is configured to create a project connector configuration based on the information of a site of the plurality of sites and workorder template of the plurality of workorder templates and automatically trigger a workorder of the plurality of workorders to the site management server based on the project connector configuration.

Accordingly, the embodiments herein disclose a method for automatically triggering workorder in the wireless network, wherein the method includes: creating and storing a plurality of workorder templates includes the plurality of site parameters of a site from the plurality of sites, information of the site related to the project connector configuration and the site identifier (ID): creating and storing at least workorder that needs to be triggered based on the workorder template from the plurality of workorder templates: creating a project connector configuration based on the information of the site of the plurality of sites and workorder template of the plurality of workorder templates; and automatically trigger the at least one workorder of the plurality of workorders based on the project connector configuration.

The conventional method for triggering the workorders is suitable for a small or single site in a single location. Unlike the conventional method, the proposed method can be used for multi-site portfolio managers, it also can be used when the site is located in multiple locations.

In some other conventional methods, user needs to create a template and uses the template to trigger the workorders manually on the site. Unlike the conventional methods, the proposed method uses the project connector to trigger the workorders automatically on the site or on a new site

Unlike the conventional method, the proposed system can trigger the workorders on the site, a facility, or a location via workflow.

Unlike conventional method, the proposed system gives the user a provision of selecting workorder template while configuring the project connector.

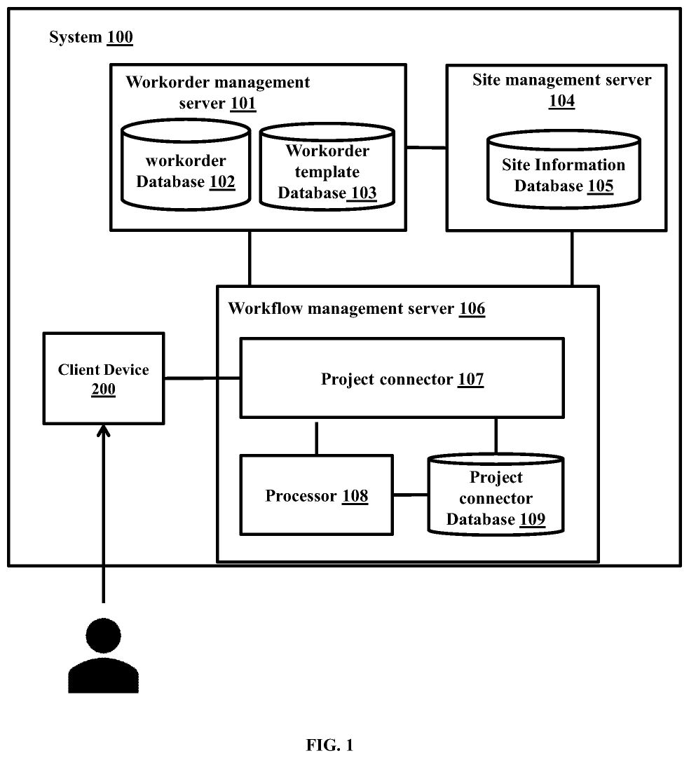

Referring now to the drawings, and more particularly to FIG. 1 through FIG. 6, there are shown preferred embodiments.

FIG. 1 is a block diagram illustrating a system (100) includes a site management server (104), a workorder management server (101) and a workflow management server (106) in a wireless network, according to the embodiments as disclosed herein.

The system includes the site management server (104), the workorder management server (101), and the workflow management server (106).

The site management server (104) includes a site information database (105) to store information of a plurality of sites in the wireless network. The site management server (104) receives a request to retrieve the information of the site from the site management server. The site management server (104) sends the information of the site using the site information database (105), wherein the information of the site includes a type of the at least one site, a technology associated with the at least one site, a category of the at least one site.

The workorder management server (101) includes a workorder database (102) and a workorder template database (103). The workorder database (102) includes a plurality of workorders and the workorder template database (103) includes a plurality of workorder templates, wherein each workorder of the plurality of workorders is created based on workorder template of the plurality of workorder templates, and wherein each workorder template of the plurality of workorder templates includes a plurality of workflows to be performed on a site of the plurality of sites.

In an embodiment, the workflow management server (106) includes a processor (108), a project connector (107), and a project connector database (109).

The workflow management server (106) includes, but are not limited to a laptop, a palmtop, a desktop, a mobile phone, a smartphone, Personal Digital Assistant (PDA), a tablet, a wearable device, an Internet of Things (IoT) device, server, a virtual reality device, a foldable device, a flexible device, an immersive system, etc

The processor (108) is configured to execute instructions from the workflow management server (106). The processor (108) may be a general-purpose processor, such as a Central Processing Unit (CPU), an Application Processor (AP), or the like, a graphics-only processing unit such as a Graphics Processing Unit (GPU), a Visual Processing Unit (VPU) and the like. The processor (108) may include multiple cores to execute the instructions.

The workflow management server (106) is configured to create a project connector configuration based on the information of the site of the plurality of sites and workorder template of the plurality of workorder templates and automatically trigger at least one workorder of the plurality of workorders to the site management server (104) based on the project connector configuration.

The workflow management server (106) is configured to creates the project connector configuration using the project connector (107) based on the information of the site of the plurality of sites and workorder template of the plurality of workorder templates includes: send a request to retrieve the information of the site from the site management server: receive the information of the site from the site management server, wherein the information of the site includes a type of the at least one site, a technology associated with the at least one site, a category of the at least one site: send a request to retrieve workorder template to the workorder management server based on the type of the at least one site, the technology associated with the at least one site, and the category of the at least one site: receive the workorder template from the workorder management server based on the type of the at least one site, the technology associated with the at least one site, and the category of the at least one site: receive a user input to automatically trigger the at least one workorder on existing site or on new site; and create the project connector configuration based on the workorder template, the user input, the type of the at least one site, the technology associated with the at least one site, and the category of the at least one site.

The workflow management server (106) is configured to detect at least one existing workflow associated with the site is completed and determine whether the project connector configuration indicates the workorder needs to be triggered for one of the sites on which the at least one existing workflow is completed or on the new site from the plurality of sites. The workflow management server (106) is further configured to automatically allocate the workorder to the project connector configuration for the site on which the existing workflow is completed when the project connector configuration indicates that the workorder needs to be triggered on the site on which the existing workflow is completed. The workflow management server (106) is further configured to determine the new site based on the project connector configuration when the project connector configuration indicates that the workorder needs to be trigged on the new site, and automatically allocates the workorder for the new site based on the project connector configuration.

The workflow management server (106) is configured to determine the new site based on the project connector configuration by mapping the site ID indicated in the project connector configuration and the site ID included in the workorder template based on which the workorder is created and triggered.

The workflow management server (106) is configured to receive input corresponding to the plurality of site parameters associated with each of the sites, and the information about each of the sites related to the project connector configuration. The workflow management server (106) is further configured to assign at least one workflow of the plurality of workflows to be performed on each of the sites and allocate the site ID to each of the sites. The workflow management server (106) is further configured to create the workorder template corresponding to each of the sites based on the plurality of site parameters, the information about the sites related to the project connector configuration, the assigned workflow, and the allocated site ID. The workflow management server (106) is further configured to store the workorder template corresponding to each of the sites in the workorder management server.

The workflow management server (106) is configured to detect workorder templates selected from the plurality of workorder templates, wherein each of the workorder templates includes the plurality of site parameters, the information about the sites related to the project connector configuration, the assigned workflow, and the allocated site ID. The workflow management server (106) is further configured to create the workorder that needs to be triggered based on the project connector based on the at least one selected workorder template and store a mapping between the created workorder that needs to be triggered and the allocated site ID included in the selected workorder template.

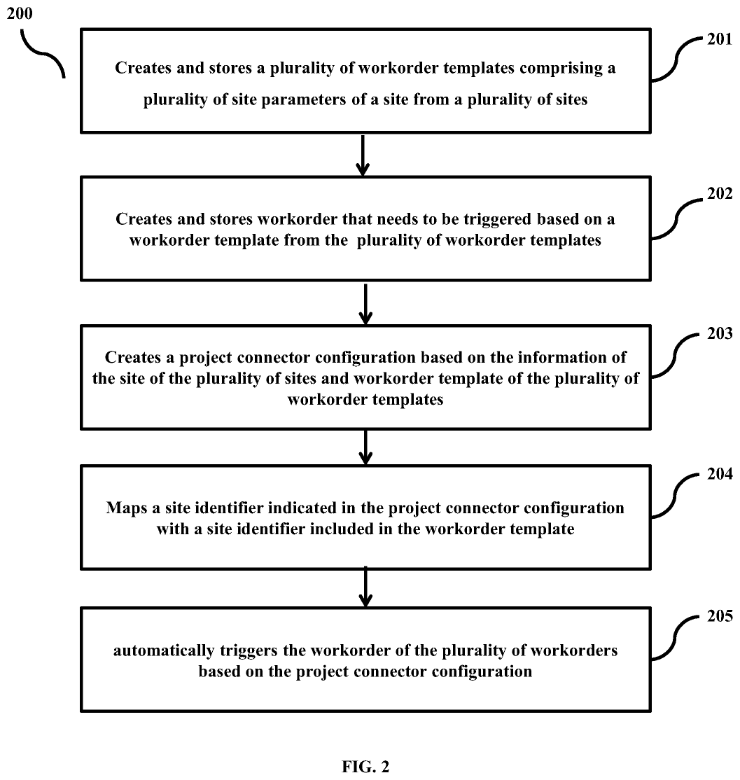

FIG. 2 is a flow diagram illustrating a method for automatically triggering workorder in the wireless network, according to the embodiments as disclosed herein.

The steps 201 to step 205 of the flow diagram (200) are performed by the Workflow management server (106).

At step 201, the Workflow management server (106) creates and stores the plurality of workorder templates includes the plurality of site parameters of the site from the plurality of sites.

At step 202, the Workflow management server (106) creates and stores workorder that needs to be triggered based on the workorder template from the plurality of workorder templates.

At step 203, the Workflow management server (106) creates the project connector configuration based on the information of the site of the plurality of sites and workorder template of the plurality of workorder templates.

At step 204, the Workflow management server (106) maps the site ID indicated in the project connector configuration with the site ID included in the workorder template.

At step 205, the Workflow management server (106) automatically triggers the workorder of the plurality of workorders based on the project connector configuration.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

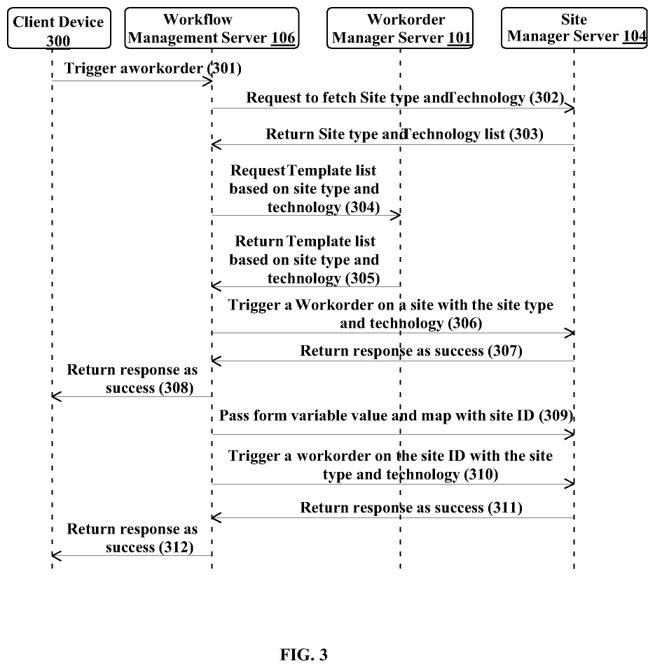

FIG. 3 is a sequential diagram illustrating the triggering of the workorder on the site or a new site ID in the wireless network, according to the embodiments as disclosed herein.

At 301, a client device (300) triggers a workorder request to the workflow management server (106). At 302 and 303, the workflow management server (106) request to fetch site type and technology (302) from the site manager server (104). At 304 and 305, the workflow management server (106) requests and receives the template list based on the fetched site type and technology. At 306, the workflow management server (106) triggers the workorder on the site with the site type and technology to the site manager server (104). At 307, the site manager server (104) sends a response as success to the workflow management server (106). At 308, the workflow management server (308) returns the response as the success to the client device (300).

When the workflow management server (106) determines the new or the new site ID site by mapping the site ID indicated in the project connector configuration. At 309, the workflow management server (106) passes form variable value and map the new site with the site ID. At 310, the workflow management server (106) triggers the workorders on the site ID with the site type and technology. At 310, the site manager server (104) sends the response as success to the workflow management server (106). At 312, the workflow management server (308) returns the response as the success to the client device (300).

The variable value can be selected from the dropdown while the configuration of the project connector, wherein the variable value is dynamic at a time of execution, so based on the site ID associated with the variable value the workorder is triggered.

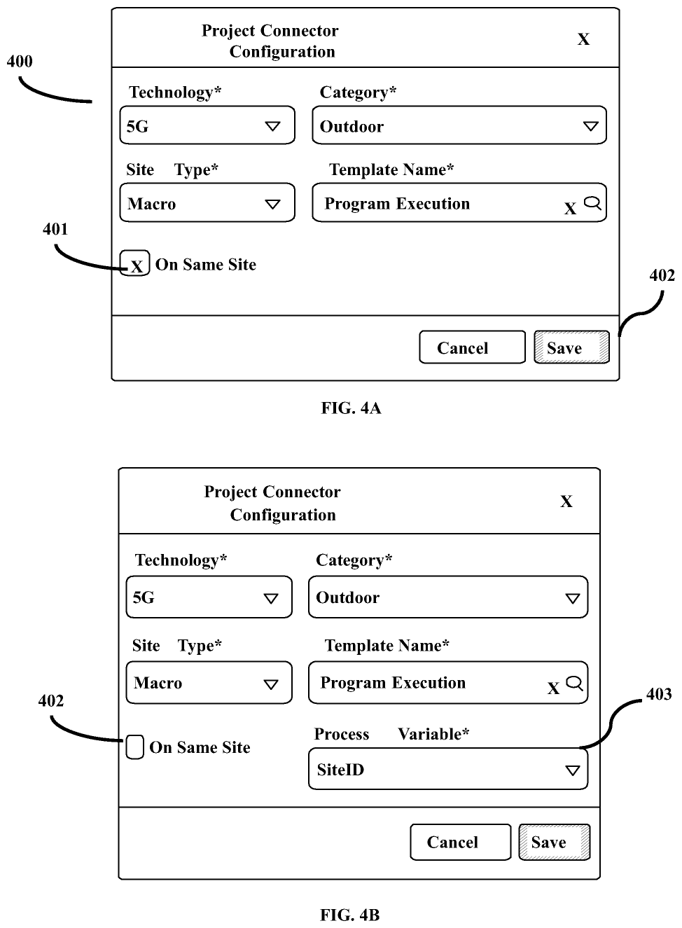

FIG. 4A is a schematic diagram illustrating the mapping of the site ID included in the workorder template of the project connector configuration (400), according to the embodiments as disclosed herein.

Multiple processes are associated with the site from planning to maintenance, and the multiple processes include different tasks to be done on the site. The multiple processes are otherwise called as the workorder and the workorder has multiple tasks associated with it. The project connector is used if the user wants to trigger the workorder after the completion of an already running workorder on the site.

When the user selects the option of the same site (401) as the mapping of the site ID included in the workorder template of the project connector configuration, the workorder will get triggered on the same site on which the workflow is already having the project connector in it. The workflow management server (106) detects that the same site option is selected at the time of workorder template creation and at the time when the workorder is triggered. The project connector and the site ID of the same site are related to triggering the workorder on the same site.

The project connector configuration (400) sends a request to retrieve the information of the site from the site management server (104). Further, the project connector configuration (400) receives the information of the site from the site management server (104), wherein the information of the site includes the type of the at least one site, the technology associated with the at least one site, the category of the at least one site. Further, the project connector configuration (400) sends the request to retrieve workorder template to the workorder management server based on the type of the at least one site, the technology associated with the at least one site, and the category of the at least one site and receive the workorder template from the workorder management server based on the type of the at least one site, the technology associated with the at least one site, and the category of the at least one site. Further, the project connector configuration (400) receives the user input as save (402) to automatically trigger the workorder on the same site (401).

The project connector configuration (400) detects at least one existing workflow associated with the site is completed and the workflow management server determines whether the project connector configuration indicates the workorder has to be triggered for one of the sites on which the at least one existing workflow is completed on the same site (401)

FIG. 4B is a schematic diagram illustrating the mapping of the new site ID indicated in the project connector configuration, according to the embodiments as disclosed herein.

Referring to FIG. 4B, when the user has not selected the option of the same site (402) in the project connector configuration a process variable option will be displayed where the user can select the variable i.e. the new site ID, in order to trigger workorder on new site. The workorder will get triggered dynamically on the new site ID at the time of execution.

When the user has not selected the option of same site (402) in the project connector configuration, the workflow management server determines the new site based on the project connector configuration. The project connector configuration receives the user input to automatically trigger the at least one workorder on the new site (402) and creates the project connector configuration based on the workorder template, the user input, the type of the at least one site, the technology associated with the at least one site, and the category of the new site. The workflow management server automatically allocates the workorder for the new site based on the project connector configuration.

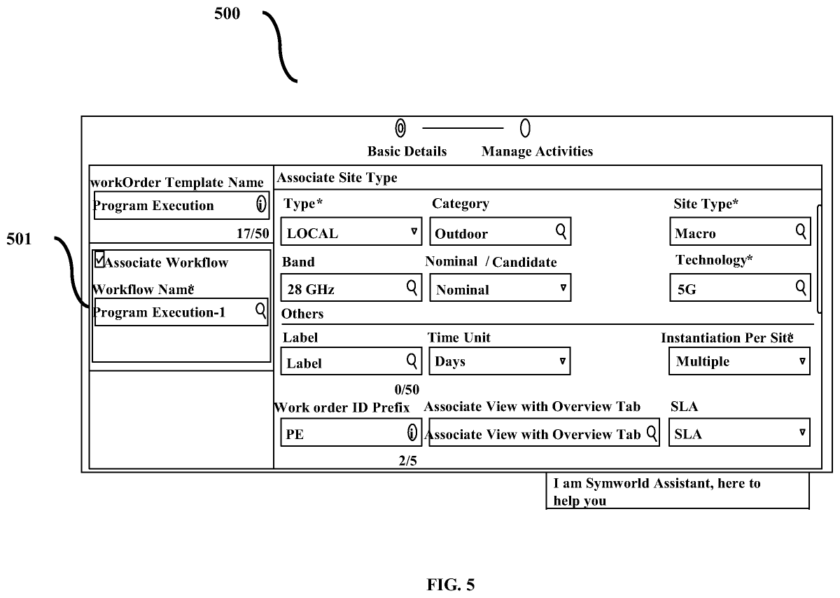

FIG. 5 is a schematic diagram illustrating the workorder template creation window (500), according to the embodiments as disclosed herein.

Workorder template creation window (500) has an associate work flow, an associate site type, and others. The workorder template is created corresponding to each of the sites based on the site parameters, the information about the sites related to the project connector configuration, the assigned workflow, and the allocated site identifier and store the workorder template corresponding to each of the sites in the workorder management server (106).

In the workorder template creation window (500), the user can associate (501) the workflow which was created inside the workflow management which has the project connector.

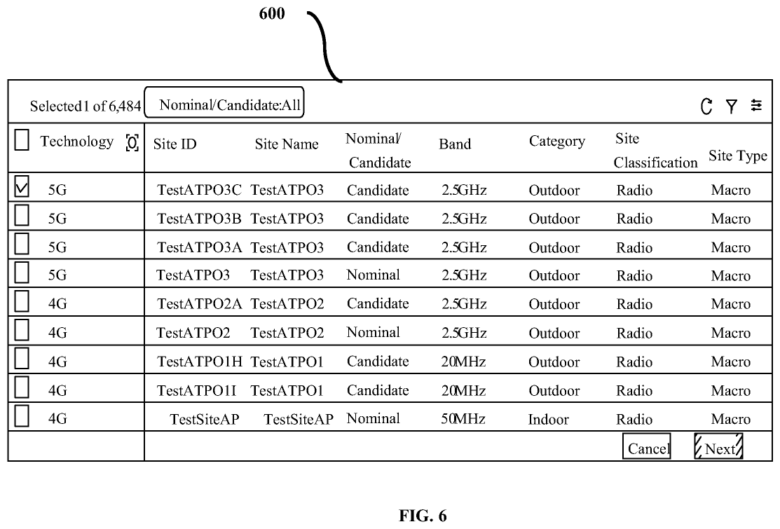

FIG. 6 is a schematic diagram illustrating the workorder creation template (600), according to the embodiments as disclosed herein.

The workorder creation window (600) is based on the workorder template which we selected while configuring the project connector. The mapping of the site ID on which the workorder will be created and the workorder is triggered by the project connector. In one embodiment the user can select the workorder template while creating the workorder and hence the workorder can be triggered on the site ID mentioned in the workorder creation window (600).

Details of the terms, the term site in the embodiments referred to antenna equipment and ground equipment which is for transmitting and receiving signals from user equipment. The term workorder referred to business process that runs on the site to execute different tasks and to complete a work. The term task referred to an entity that defines the work to be done on the site.

Therefore, the proposed method includes the following advantages:

The proposed system and method automate the process of triggering workorder on the site, facility, or location via workflow, and hence it is a simple and easy way of triggering workorder.
1. The proposed system and method provide a user-friendly interface and it requires minimal configuration.
2. The proposed system and method give the user a provision of selecting the workorder template created in workorder while project connector configuration.
3. The proposed system and method allow the user to trigger workorder on the same site or on the new site ID provided on run time.
4. The proposed system and method can be used for multi-site portfolio managers, it also can be used when the site is located in multiple locations.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A system for automatically triggering workorder in a wireless network, wherein the system includes:
a site management server includes information of a plurality of sites;
a workorder management server includes a plurality of workorders and a plurality of workorder templates, wherein each workorder of the plurality of workorders is created based on workorder template of the plurality of workorder templates, and wherein each workorder template of the plurality of workorder templates includes a plurality of workflows to be performed on a site of the plurality of sites; and
a workflow management server, communicatively coupled to the workorder management server and the site management server, configured to:
create a project connector configuration based on the information of a site of the plurality of sites and workorder template of the plurality of workorder templates; and
automatically trigger at least one workorder of the plurality of workorders to the site management server based on the project connector configuration.

2. The system as claimed in claim 1, wherein create the project connector configuration based on the information of a site of the plurality of sites and workorder template of the plurality of workorder templates includes:
send a request to retrieve the information of the site from the site management server;
receive the information of the site from the site management server, wherein the information of the site includes a type of the at least one site, a technology associated with the at least one site, a category of the at least one site;
send a request to retrieve workorder template to the workorder management server based on the type of the at least one site, the technology associated with the at least one site, and the category of the at least one site;
receive the workorder template from the workorder management server based on the type of the at least one site, the technology associated with the at least one site, and the category of the at least one site;
receive a user input to automatically trigger the at least one workorder on existing site or on new site; and
create the project connector configuration based on the workorder template, the user input, the type of the at least one site, the technology associated with the at least one site, and the category of the at least one site.

3. The system as claimed in claim 1, wherein automatically trigger at least one workorder of the plurality of workorders to the site management server based on the project connector configuration includes;
detect at least one existing workflow associated with the site is completed;
determine whether the project connector configuration indicates the at least one workorder needs to be triggered for one of the site on which the at least one existing workflow is completed or on a new site from the plurality of sites; and
perform one of:
automatically allocate the at least one workorder the project connector configuration for the site on which the at least one existing workflow is completed when the project connector configuration indicates that the at least one workorder needs to be triggered on the site on which the at least one existing workflow is completed; and
determine the new site based on the project connector configuration when the project connector configuration indicates that the at least one workorder needs to be trigged on the new site, and automatically allocate the at least one workorder for the new site based on the project connector configuration.

4. The system as claimed in claim 3, wherein determine the new site based on the project connector configuration by mapping a site identifier indicated in the project connector configuration and a site identifier included in the workorder template based on which the at least one workorder is created to be triggered.

5. The system as claimed in claim 1, wherein the workorder management server is configured to:
receive input corresponding to a plurality of site parameters associated with each of the sites, and the information about each of the sites related to the project connector configuration;
assign at least one workflow of the plurality of workflows to be performed on each of the sites;
allocate a site identifier to each of the sites; and
create a workorder template corresponding to each of the sites based on the plurality of site parameters, the information about the sites related to the project connector configuration, the at least one assigned workflow, and the allocated site identifier; and
store the workorder template corresponding to each of the sites in the workorder management server.

6. The system as claimed in claim 5, wherein the workorder management server is configured to:
detect workorder template selected form the plurality of workorder templates, wherein each of the workorder templates includes the plurality of site parameters, the information about the sites related to the project connector configuration, the at least one assigned workflow, and the allocated site identifier; and
create the at least one workorder that needs to be triggered based on the project connector based on the at least one selected workorder template; and
store a mapping between the at least one created workorder that needs to be triggered and the allocated site identifier included in the at least one selected workorder template.

7. A method for automatically triggering workorder in a wireless network, wherein the method includes:
creating and storing a plurality of workorder templates includes a plurality of site parameters of a site from a plurality of sites, information of the site related to a project connector configuration and a site identifier;
creating and storing at least workorder that needs to be triggered based on a workorder template from the plurality of workorder templates;
creating a project connector configuration based on the information of the site of the plurality of sites and workorder template of the plurality of workorder templates; and
automatically trigger the at least one workorder of the plurality of workorders based on the project connector configuration.

8. The method as claimed in claim 7, wherein creating the project connector configuration based on the information of the site of the plurality of sites and the workorder template of the plurality of workorder templates includes:
sending by a workflow management server a request to retrieve the information of the site from a site management server;
receiving by the workflow management server the information of the site from the site management server, wherein the information of the site includes a type of the at least one site, a technology associated with the at least one site, a category of the at least one site;
sending by the workflow management server a request to retrieve the workorder template to the workorder management server based on the type of the at least one site, the technology associated with the at least one site, and the category of the at least one site;
receiving by the workflow management server the workorder template from the workorder management server based on the type of the at least one site, the technology associated with the at least one site, and the category of the at least one site;
receiving by the workflow management server a user input to automatically trigger the at least one workorder on existing site or on new site; and
creating by the workflow management server the project connector configuration based on the workorder template, the user input, the type of the at least one site, the technology associated with the at least one site, and the category of the at least one site.

9. The method as claimed in claim 7, wherein automatically triggering at least one workorder of the plurality of workorders to the site management server based on the project connector configuration includes:
detecting by the workflow management server at least one existing workflow associated with the site is completed;
determining by the workflow management server whether the project connector configuration indicates the at least one workorder needs to be triggered for one of the site on which the at least one existing workflow is completed or on a new site from the plurality of sites; and
performing by the workflow management server one of:
automatically allocate the at least one workorder the project connector configuration for the site on which the at least one existing workflow is completed when the project connector configuration indicates that the at least one workorder needs to be triggered on the site on which the at least one existing workflow is completed; and
determine the new site based on the project connector configuration when the project connector configuration indicates that the at least one workorder needs to be trigged on the new site, and automatically allocate the at least one workorder for the new site based on the project connector configuration.

10. The method as claimed in claim 9, wherein determine the new site based on the project connector configuration by mapping a site identifier indicated in the project connector configuration and a site identifier included in the workorder template based on which the at least one workorder is created to be triggered.

11. The method as claimed in claim 7, wherein creating and storing the plurality of workorder templates includes:
receiving by the workorder management server input corresponding to the plurality of site parameters associated with each of the sites, and the information about each of the sites related to the project connector;
assigning by the workorder management server at least one workflow of the plurality of workflows to be performed on each of the sites;
allocating by the workorder management server a site identifier to for each of the sites; and
creating by the workorder management server a workorder template corresponding to each of the sites based on the plurality of site parameters, the information about the sites defining the project connector, the at least one assigned workflow, and the allocated site identifier; and
storing by the workorder management server the workorder template corresponding to each of the sites in the workorder management server.

12. The method as claimed in claim 7, wherein creating and storing the at least one workorder that needs to be triggered includes:
detecting by the workorder management server workorder template selected form the plurality of workorder templates, wherein each of the workorder templates includes the plurality of site parameters, the information about the sites defining the project connector, the at least one assigned workflow, and the allocated site identifier; and
creating by the workorder management server the at least one workorder that needs to be triggered based on the project connector based on the at least one selected workorder template; and
storing by the workorder management server a mapping between the at least one created workorder that needs to be triggered and the allocated site identifier included in the at least one selected workorder template.
